(19) United States
(12) Patent Application Publication
(10) Pub. No.: US 2009/0160311 A1
(43) Pub. Date: Jun. 25, 2009

(54) Light-emitting device, power feeding device, and power feeding method

(75) Inventors: Mutsumi Kubota, Tokyo (JP); Mamoru Fukuda, Tokyo (JP); Hiroaki Ishii, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: RISO KAGAKU CORPORATION, Tokyo (JP)

(21) Appl. No.: 12/292,074

(22) Filed: Nov. 12, 2008

(30) Foreign Application Priority Data
Dec. 20, 2007 (JP) 2007-328977

(51) Int. Cl. H05B 33/06

(52) U.S. Cl. 313/494

(57) ABSTRACT

An EL light-emitting device includes an insulating board, to which an EL light-emitting sheet is fixed on a front surface of the insulating board for allowing penetration, an output terminal disposed on a back surface of the insulating board, which exhibits conductivity and allows penetration, a drive circuit connected to the output terminal, and a conductive member with a pointed portion which fixes the EL light-emitting sheet to the front surface of the insulating board, and conducts the electrode of the EL light-emitting sheet and the output terminal by penetrating the electrode of the EL light-emitting sheet and the output terminal. The force for fixing a sheet EL element is sufficiently strong such that plural sheet EL elements are attached through simple installation work.

### BACKGROUND OF THE INVENTION

1. Field of the Invention

The present invention relates to a power feeding device which fixes a power receiving unit to a board with a pin through which power is fed to allow the power receiving unit to emit light, and a power feeding method using the power feeding device. More specifically, the present invention relates to an electroluminescence light-emitting device for fixing an electroluminescence light-emitting sheet to the board with the pin through which power is fed to allow the attached electroluminescence sheet to emit light as specific examples of the aforementioned power feeding device and the power feeding method.

2. Description of the Related Art

An electroluminescence light-emitting element (hereinafter referred to as EL light-emitting element) may be formed into a thin sheet so as to be disposed in small space, and intended to be utilized for an advertizing medium and other display means. The thin sheet EL element cannot stand by itself, and accordingly, the display device is required for putting the EL element on display in a predetermined state and feeding power to display.

Registered Utility Model No. 3131658 discloses the EL light-emitting device which easily puts the sheet EL element which cannot stand on display at a desired position, and easily feeds power for display. The EL light-emitting device has a main body and the upper cover hinged like a clip so as to be opened and closed, while being urged to the closing direction by the spring. The output terminal on the upper surface of the main body is connected to the internal power source and the drive circuit. The electrode of the sheet EL light-emitting element may be gripped in the gap between the main body and the upper cover, and closed so that the sheet EL light-emitting element is retained, and the output terminal and the electrode are conducted in contact. The main body is mounted on the desired position using detachable fixing means, and the power switch is turned ON to put the sheet EL light-emitting element on display at the desired position for light emission display.

The EL light-emitting device as disclosed in Registered Utility Model No. 3131658 is of clip type for clipping the sheet EL element to be retained.

As the clipping force is not sufficiently strong, the sheet EL element retained by the EL light-emitting device is likely to fall out therefrom when it is pulled in the plane direction orthogonal to the clipping direction.

The sheet EL element is required to be clipped while correctly aligning its electrode with the electrode of the EL light-emitting device for power feeding, resulting in cumbersome work.

Plural the sheet EL elements cannot be attached to the EL light-emitting device in a state whether they are overlapped or not.

As the cycle of the drive signal transmitted to the attached sheet EL element cannot be arbitrarily selected by the simple structure, it is difficult to arbitrarily set the light emitting cycle.

It is an object of the present invention to provide an EL light-emitting device which generates strong force for fixing the sheet EL element, allows easy attachment operation even in the case of plural sheet EL elements, and arbitrarily selects the cycle of the drive signal to the mounted sheet EL element to freely set the light emitting cycle.

It is another object of the present invention to provide a power feeding device structured to allow a power receiving unit to be easily attached to the board for receiving power and a power feeding method.

### SUMMARY OF THE INVENTION

The present invention provides an EL light-emitting device which fixes an EL light-emitting sheet with an electrode for light emission. The EL light-emitting device includes an insulating board which allows penetration and fixation of the EL light-emitting sheet on a front surface, an output terminal provided on a back surface of the insulating board, which exhibits conductivity and allows penetration, a drive circuit connected to the output terminal, and a conductive member with a pointed portion for fixing the EL light-emitting sheet to a desired position on the front surface of the insulating board and conducting the electrode of the EL light-emitting sheet and the output terminal by penetrating the electrode of the EL light-emitting sheet disposed on the front surface of the insulating board, the insulating board, and the output terminal.

In the EL light-emitting device according to the present invention, the EL light-emitting device includes a pair of the output terminals, and the conductive member is separated with an insulating separation member which inhibits penetration of the conductive member. The EL light-emitting sheet includes a pair of the electrodes corresponding to the pair of the output terminals.

The present invention provides an EL light-emitting device which includes an insulating board which allows penetration, a pair of comb-like output terminals disposed on a back surface of the insulating board which are combined at a pitch of L, each exhibiting conductivity and allowing penetration, a drive circuit connected to the output terminal, an EL light-emitting sheet disposed on a front surface of the insulating board, which includes a pair of electrodes arranged at an interval of (2n+1)L to correspond to the pair of the output terminals, and a conductive member with a pointed portion for fixing the EL light-emitting sheet to a desired position on the front surface of the insulating board, and conducting the electrode of the EL light-emitting sheet and the output terminal by penetrating the pair of the electrodes of the EL light-emitting sheet disposed on the front surface of the insulating board, the insulating board, and the pair of the output terminals.

The present invention provides an EL light-emitting device which fixe an EL light-emitting sheet with an electrode for light emission. The EL light-emitting device includes plural insulating boards each allowing penetration, one of which is disposed on a front surface, plural output terminals each exhibiting conductivity and allowing penetration, which are alternately overlapped with the insulating boards in a width direction, a drive circuit connected to the output terminals to transmit drive signals each at a different cycle, and a conductive member with a pointed portion for fixing the EL light-emitting sheet to a desired position on a front surface of the insulating board, and conducting the electrode of the EL light-emitting sheet and only the desired output terminal by penetrating the electrode of the EL light-emitting sheet disposed on the front surface of the insulating board located at the front, the insulating board, and the output terminal.

In the EL light-emitting device according to the present invention, the EL light-emitting device includes a pair of the output terminals, and the pair of the output terminals at least disposed on the front surface are separated with an insulating separation member which inhibits penetration of the conductive member. The pair of electrodes of the EL light-emitting sheet corresponds to the pair of the output terminals.

In the EL light-emitting device according to the present invention, the conductive member includes an insulating knob and a pin formed of a conductive material which is attached to the knob to penetrate the electrode of the EL light-emitting sheet, the insulating board, and the output terminal, and conducts only with the output terminal in contact with a leading end portion.

The present invention provides a power feeding device for feeding power to a power receiving unit with an electrode. The power feeding device includes an insulating board which allows penetration, an output terminal disposed on a back surface of the insulating board, which exhibits conductivity and allows penetration, a drive circuit connected to the output terminal, and a conductive member with a pointed portion for conducting the electrode of the power receiving unit and the output terminal by penetrating the electrode of the power receiving unit disposed on a front surface of the insulating board, the insulating board, and the output terminal.

The present invention provides a power feeding method for feeding power to a power receiving unit with an electrode using a power feeding device provided with an output terminal which exhibits conductivity and allows penetration connected to a drive circuit on a back surface of the insulating board which allows penetration. A conductive member with a pointed portion penetrates the electrode of the power receiving unit on a front surface of the insulating board, the insulating board, and the output terminal to conduct the electrode of the power receiving unit and the output terminal via the conductive member.

In the EL light-emitting device according to the present invention, the EL light-emitting sheet is disposed at a desired position on the front surface of the insulating board, and the conductive member is allowed to penetrate the insulating board through the electrode of the EL light-emitting sheet. The conductive member further penetrates the output terminal beneath the insulating board. This makes it possible to fix the EL light-emitting sheet at the desired position on the front surface of the insulating board, and at the same time, the electrode of the EL light-emitting sheet and the output terminal are conducted. As the drive signal from the drive circuit may be transmitted to the output terminal, the EL light-emitting sheet displayed on the insulating board of the EL light-emitting device may be driven for light emission.

In the EL light-emitting device according to the present invention, the pair of output terminals of the EL light-emitting device is separated with the hard insulating separation member which inhibits penetration of the conductive member. This may easily notify the user of the positional displacement between the electrode of the EL light-emitting sheet and the output terminal of the EL light-emitting device when the conductive member does not get stuck. In this way, the pair of electrodes of the EL light-emitting sheet may be connected to the pair of output terminals of the EL light-emitting device correspondingly.

In the EL light-emitting device according to the present invention, the interval between the pair of electrodes of the EL light-emitting sheet is (2n+1)L with respect to a pitch L of the adjacent comb-like output terminals to which the EL light-emitting sheet is attached. The pair of the output terminals of the EL light-emitting device and the pair of electrodes of the EL light-emitting sheet maybe conducted correspondingly by disposing the EL light-emitting sheet at the desired position on the front surface of the insulating board, allowing the conductive member to penetrate the insulating board through the electrode of the EL light-emitting sheet, and further allowing the conductive member to penetrate the output terminal beneath the insulating board to attach the EL light-emitting sheet to the EL light-emitting device.

In the EL light-emitting device according to the present invention, the plural insulating boards and the plural output terminals are alternately overlapped while having the insulating board disposed as the front surface The electrode of the EL light-emitting sheet may be selectively connected and conducted to the desired output terminal for generating the drive signal at the desired cycle by selecting an appropriate conductive member among those of plural types so as to be used for fixing the EL light-emitting sheet. The EL light-emitting sheet may be driven for light emission at the desired cycle.

In the EL light-emitting device according to the present invention, the pair of output terminals of the EL light-emitting device is separated with the hard insulating separation member which does-not allow penetration of the conductive member. This makes it possible to easily notify the user of the positional displacement between the electrode of the EL light-emitting sheet and the output terminal of the EL light-emitting device when the conductive member does not penetrate. Accordingly, the pair of electrodes of the EL light-emitting sheet and the pair of output terminals of the EL light-emitting device may be connected correspondingly.

In the EL light-emitting device according to the present invention, the pin is pushed into the electrode of the EL light-emitting sheet so as to be attached to the EL light-emitting device while pinching the insulating knob by the fingers to ensure safe operation. The pin of the conductive member is formed of the conductive material, and structured not to conduct the penetrated output terminal by covering the portion other than the leading end with the insulating material, for example. The output terminal in contact with the leading end is only conducted so as to supply only the drive signal at the desired cycle to the EL light-emitting sheet.

In the power feeding device or the power feeding method according to the present invention, the power receiving unit is disposed at the desired position on the front surface of the insulating board to allow the conductive member to penetrate the insulating board through the electrode of the power receiving unit. It further penetrates the output terminal beneath the insulating board. This may fix the power receiving unit to the desired position on the front surface of the insulating board. The electrode of the power receiving unit and the output terminal may be conducted to transmit the drive signal from the drive circuit to the output terminal. Accordingly, the power receiving unit attached to the insulating board of the power feeding device may be driven for light emission.

### BRIEF DESCRIPTION OF THE DRAWINGS

FIG. 1 is a perspective view of an EL light-emitting device according to a first embodiment;

FIG. 2 is a sectional view of the EL light-emitting device according to the first embodiment;

FIG. 3 is a perspective view of the EL light-emitting device according the first embodiment in a usage state;

FIG. 4 is a perspective view of an EL light-emitting device according to a second embodiment;

FIG. 5 is a sectional view of the EL light-emitting device according to the second embodiment;

FIG. 6 is a view showing a relationship with respect to the pitch between the output terminal of the EL light-emitting device according to the second embodiment and the electrodes 3 of the EL light-emitting sheet;

FIG. 7 is a perspective view of the EL light-emitting device according to the second embodiment in the usage state;

FIG. 8 is a perspective exploded view showing a structure of an EL light-emitting device according to a third embodiment;

FIG. 9 is a sectional view of the EL light-emitting device according to the third embodiment;

FIG. 10 is a front view showing a conductive member of the EL light-emitting device according to the third embodiment; and

FIG. 11 shows an exemplary waveform of the drive signal generated by the EL light-emitting device according to the third embodiment.

### DETAILED DESCRIPTION

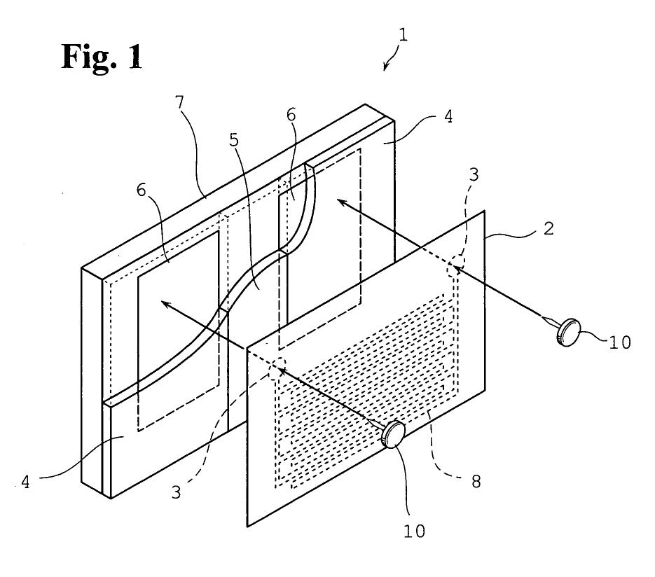

Embodiments of the present invention considered as being the best mode will be described referring to FIGS. 1 to 11.

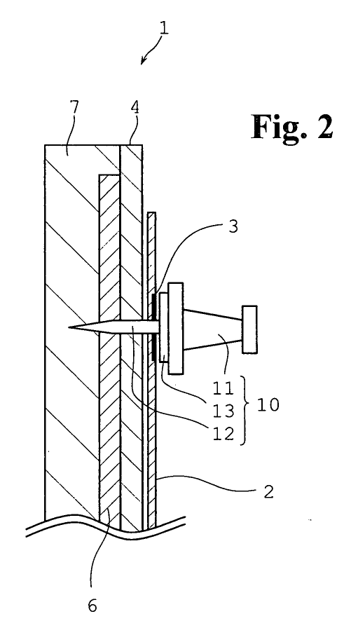

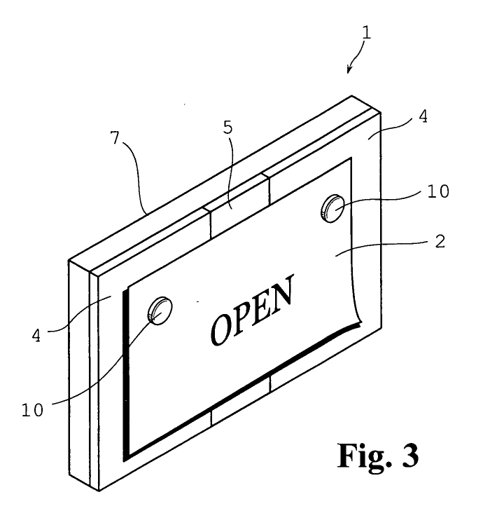

A first embodiment is shown in FIGS. 1 to 3. FIG. 1 is a perspective view of an EL light-emitting device according to the first embodiment. FIG. 2 is a sectional view of the EL light-emitting device according to the first embodiment. FIG. 3 is a perspective view showing the EL light-emitting device according to the first embodiment in a usage state.

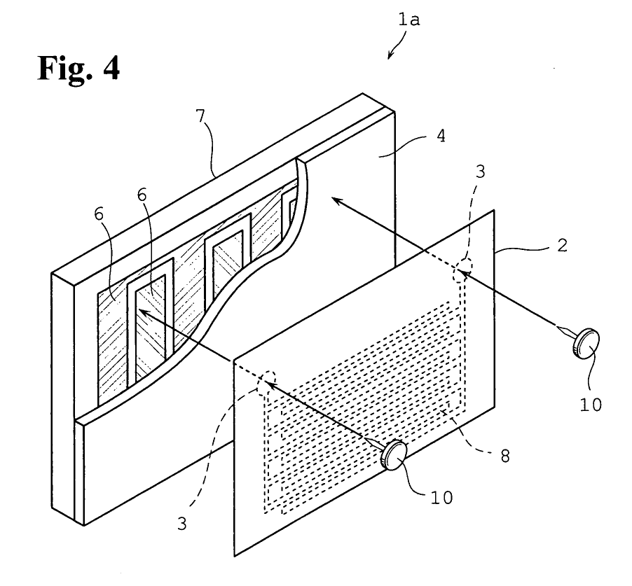

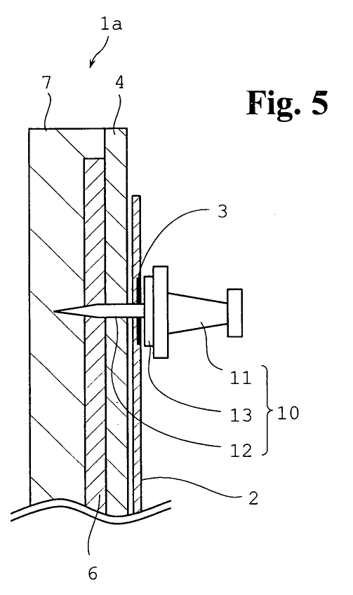

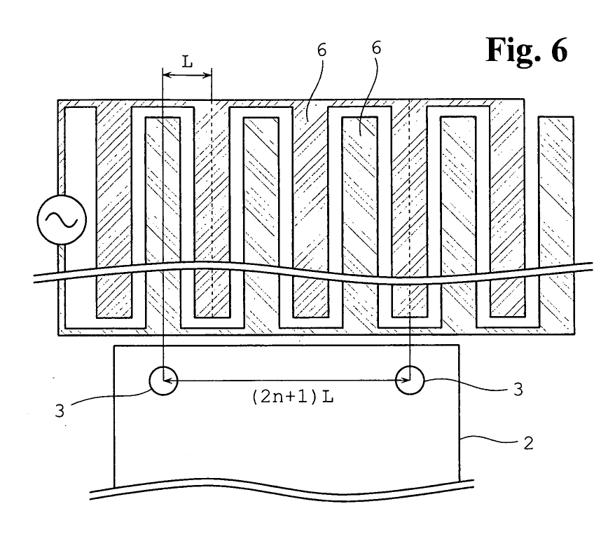

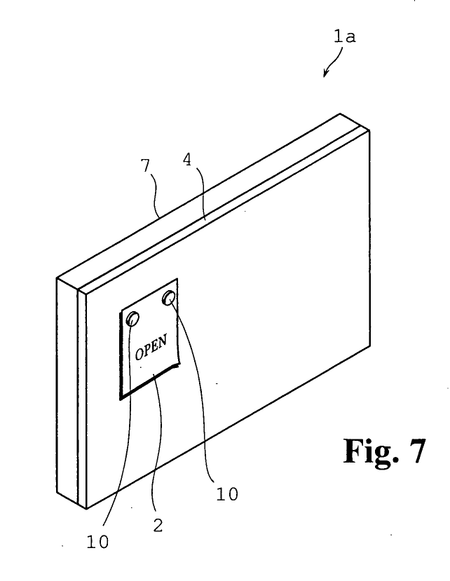

A second embodiment is shown in FIGS. 4 to 7. FIG. 4 is a perspective view of an EL light-emitting device according to the second embodiment. FIG. 5 is a sectional view of the EL light-emitting device according to the second embodiment. FIG. 6 is a view showing the relationship with respect to the pitch between the output terminal of the EL light-emitting device according to the second embodiment and the electrodes of the EL light-emitting sheet. FIG. 7 is a perspective view showing the EL light-emitting device according to the second embodiment in the usage state.

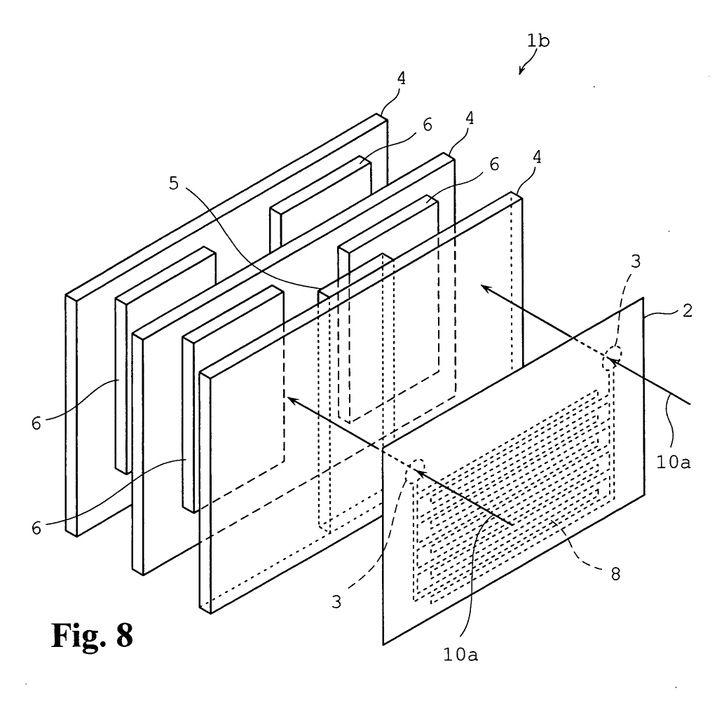

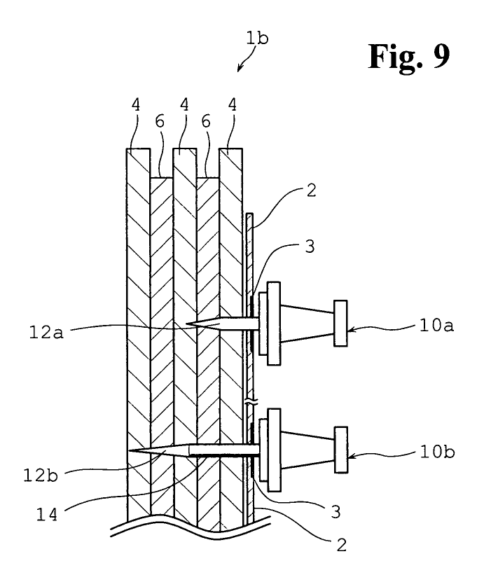

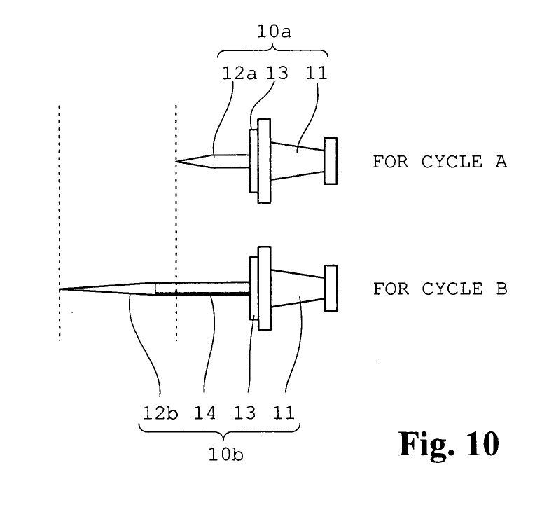

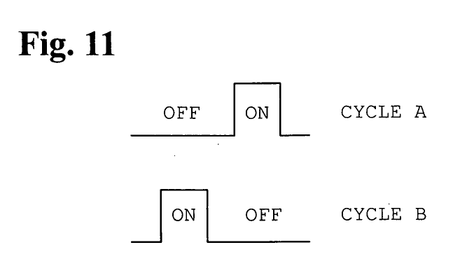

FIGS. 8 to 11 show a third embodiment. FIG. 8 is an exploded perspective view showing a state of the EL light-emitting device according to the third embodiment. FIG. 9 is a sectional view of the EL light-emitting device according to the third embodiment. FIG. 10 is a front view showing the conductive member of the EL light-emitting device according to the third embodiment. FIG. 11 shows an exemplary waveform of the drive signal of the EL light-emitting device according to the third embodiment.

### 1. First Embodiment (First Example, FIGS. 1 to 3)

An EL light-emitting device according to a first embodiment allows the EL light-emitting sheet to be easily attached to or detached from the desired position, and is capable of feeding power. Specifically, the EL light-emitting sheet is fixed onto the insulating board using a conductive member configured as a pushpin to bring the electrode of the EL light-emitting sheet into contact with the output terminal disposed at a back surface side of the insulating board via the conductive member for power supply. The output terminal may be formed of a material which exhibits conductivity and allows penetration such as a conductive rubber and conductive urethane foam. A pair of output terminals is disposed at left and right sides, and a hard insulating separation member is disposed in the center therebetween for preventing the improper connection.

An EL light-emitting device 1 of the embodiment shown in FIGS. 1 and 2 is intended to allow an fixed EL light-emitting sheet 2 having electrodes 3 to emit light. The EL light-emitting device 1 includes an insulating board 4 formed of an insulating material to which the EL light-emitting sheet 2 is fixed to the front surface, for example, cork. The insulating board 4 as a laterally long rectangular board having both left and right sides formed of the insulating material which allows penetration, and having a hard insulating separation member 5 in the center between the left and right sides, which is formed of a material that does not allow penetration of the pushpin-like conductive member therethrough, for example, plastic material.

A back surface of the insulating board 4 is provided with a pair of output terminals 6 each as a rectangular board formed of a material which exhibits conductivity and allows penetration such as the conductive rubber and conductive urethane foam. A not shown drive circuit is connected to each of the output terminals 6 so as to be AC driven at a predetermined cycle. Referring to FIG. 1, the output terminals 6, 6 are separated with the insulating separation member 5 in the center of the insulating board 4 to the left and right sides so as to correspond to a pair of electrodes 3, 3 of the EL light-emitting sheet 2 upon attachment thereof.

Back surfaces of the insulating board 4, the separation member 5 and the output terminals 6 are covered with an insulating back board 7.

Referring to FIGS. 1 and 2, the EL light-emitting sheet 2 is attached to the front surface of the insulating board 4 of the EL light-emitting device 1. The EL light-emitting sheet 2 is obtained by sealing a sheet-like EL light-emitting element formed of a lamination structure including an insulating base material sheet, a back electrode 8 on the base material sheet, an insulating layer on the back electrode 8, a light-emitting layer with a desired light-emitting pattern on the insulating layer, and a transparent electrode on the light-emitting layer with a sheet-like sealing member in an air-tight state. A pair of electrodes 3 conducted to a pair of comb-like electrodes as the back electrode 8 is exposed to the surface.

Referring to FIG. 2, the EL light-emitting device 1 includes a pushpin-like pointed conductive member 10 used for attaching the EL light-emitting sheet 2 to the front surface of the insulating board 4 of the EL light-emitting device 1, and conducting the output terminals 6 of the EL light-emitting device 1 and the electrodes 3 of the EL light-emitting sheet 2. The conductive member 10 includes an insulating knob 11, a pointed pin 12 attached to the knob, which is formed of the conductive material, and a conductive contact member 13 attached to the bottom surface of the knob 11 in contact with the proximal end of the pin 12, which is smaller than the outline of the bottom surface of the knob 11. The length of the pin 12 is longer than a total value of thicknesses of the insulating board 4 and the output terminal 6 such that it does not penetrate through the back board 7. The contact member 13 is formed for stabilizing electric coupling between the EL light-emitting sheet 2 and the EL light-emitting device 1.

Referring to FIGS. 1 to 3, the EL light-emitting sheet 2 is attached to the front surface of the insulating board 4 of the EL light-emitting device 1 by locating the EL light-emitting sheet 2 at a desired position on the front surface of the insulating board 4, allowing the pin 12 to penetrate the electrodes 3 of the EL light-emitting sheet 2 while holding the knob 11 of the conductive member 10 and further to penetrate the insulating board 4 to reach the output terminals 6 beneath the insulating board 4. This makes it possible to fix the EL light-emitting sheet 2 to the desired position on the front surface of the insulating board 4 and to conduct the electrodes 3 of the EL light-emitting sheet 2 and the output terminals 6. The drive signal may be transmitted to the electrodes 3 of the EL light-emitting device 1 via the pin 12 of the conductive member 10 by transmitting the drive signal of the drive circuit at AC voltage to the output terminals 6. As a result, the EL light-emitting sheet 2 attached to the insulating board 4 of the EL light-emitting device 1 may be driven for light emission.

In the embodiment, the pair of output terminals 6, 6 of the EL light-emitting device 1 is disposed at left and right sides separated with the hard insulating separation member 5 which inhibits penetration of the conductive member 10. When the conductive member 10 abuts on the separation member 5 rather than penetrating upon attachment of the EL light-emitting sheet 2 onto the front surface of the insulating board 4 with the conductive member 10, the user may be easily notified that the electrodes 3 of the EL light-emitting sheet 2 deviate from the corresponding positions of the output terminals 6 of the EL light-emitting device 1. The user is allowed to connect the pair of electrodes 3, 3 of the EL light-emitting sheet 2 to the pair of output terminals 6, 6 of the EL light-emitting device 1 in the normally aligned state.

As described above, the EL light-emitting device 1 of the example allows the EL light-emitting sheet 2 to be fixed easily only by pushing the pushpin-like conductive member 10 into the insulating board 4 for light emission.

The user is allowed to easily exchange the EL light-emitting sheet 2 repeatedly in such a case where the content of the advertising display is frequently changed in a short period.

The carbon as a low cost material may be used as the conductive material for eliminating such operations as wiring of the lead wire and connector and soldering on the EL light-emitting sheet 2.

The EL light-emitting device 1 has a simple structure with high productivity.

The EL light-emitting sheet 2 may be disposed and fixed at the arbitrary position on the insulating board 4 to dispose a display with high degree of freedom.

In the case where a high voltage in the order of several-hundred volts is applied to the inorganic EL for light emission, such risk as electric shock may be prevented by the safe structure for protecting the user from direct contact of the electrodes 3 by means of the insulating knob 11 in the pushpin-like pointed conductive member 10.

### 2. Second Embodiment (Second Example, FIGS. 4 to 7)

Basically, an EL light-emitting device 1a shown in FIGS. 4 and 5 has the same structure as the one described in the first example. The structure shown in FIGS. 4 and 5 with the functions corresponding to those described in the first example will be designated with the same reference numerals shown in FIGS. 1 to 3, and explanations thereof, thus will be omitted in the embodiment.

Referring to FIGS. 4 and 6, the output terminals 6, 6 are comb-like arranged in contact with each other at a constant interval. Referring to FIG. 6, when the pitch of the comb-like arrangement of the adjacent output terminals 6, 6 in the combined state is set to L, the distance between the electrodes 3 of the EL light-emitting sheet 2 is (2n+1)L or (2n−1)L. Accordingly, as shown in FIG. 7, in the case where the EL light-emitting sheet 2 is fixed to the arbitrary position on the insulating board 4 of the EL light-emitting device 1a in the lateral direction, the positional relationship between the electrodes 3, 3 of the EL light-emitting sheet 2 and the respective output terminals 6, 6 of the EL light-emitting device 1a is always kept in good alignment.

Besides the effects which are the same as those of the first embodiment, the EL light-emitting device 1a of the embodiment allows the user to arrange and fix the EL light-emitting sheet 2 to the arbitrary position without considering the positions of the output terminals 6 on the back surface of the insulating board 4.

### 3. Third Embodiment (Third Example, FIGS. 8 to 11)

An EL light-emitting device 1b according to the embodiment shown in FIGS. 8 and 9 basically has the same structure as that of the first embodiment. The structures with the same functions shown in FIGS. 8 and 9 as those of the first example will be designated as the same reference numerals shown in FIGS. 1 to 3, and explanations thereof, thus will be omitted.

Referring to FIGS. 8 and 9, the EL light-emitting device 1b having the same basic structure as that of the first example is structured to overlap plural insulating boards 4 and output terminals 6 alternately one by one between the front and back surfaces each as the insulating board 4. In the drawings, two output terminals 6 are alternately overlapped with three insulating boards 4.

Referring to FIGS. 9 and 10, two types of pushpin-like pointed conductive members 10 each having a different length are prepared in accordance with two types of differently positioned output terminals 6. The conductive members penetrate the electrode 3 of the EL light-emitting sheet 2 on the front surface of the front insulating board 4, one or two insulating boards 4, and one or two output terminals 6 such that the EL light-emitting sheet 2 is fixed to the desired position on the front surface of the insulating board 4, and the electrode 3 of the EL light-emitting sheet 2 is conducted only with the desired output terminal 6.

The length of a pin 12a of a short conductive member 10a is set such that when it is pushed up to the proximal portion of the knob 11 shown in FIG. 9, the leading end is stuck into the second insulating board 4 from the front surface but does not penetrate. As shown in FIG. 9, the length of a pin 12b of a long conductive member 10b is set such that when it is pushed up to the proximal portion of the knob 11, the leading end is stuck into the third insulating board 4 from the front surface but does not penetrate. An insulating portion 14 for preventing the electric contact is provided on the peripheral surface of the pin 12b of the long conductive member 10b, which is in contact with the first output terminal 6 from the front surface.

As shown in FIG. 9, when the EL light-emitting sheet 2 is fixed to the EL light-emitting device 1 using the short conductive member 10a, the output terminal 6 at the front side is connected to the EL light-emitting sheet 2 via the conductive member 10a. When the EL light-emitting sheet 2 is fixed to the EL light-emitting device 1 using the long conductive member 10b, the output terminal 6 at the back side is connected to the EL light-emitting sheet 2 via the conductive member 10b. In this case, as the pin 12b of the conductive member 10b which penetrates the output terminal 6 at the front side is provided with the insulating portion 14, the output terminal 6 at the front side and the conductive member 10b are not conducted, and accordingly, the output terminal 6 at the front side is not connected to the EL light-emitting sheet 2.

The output terminals 6, 6 are structured to receive drive signals from the not shown drive circuit each with the different cycle as shown in FIG. 11. In the example, the output terminal 6 at the front side receives the drive signal at cycle A, and the output terminal 6 at the back side receives the drive signal at cycle B. The light emitting cycle of the fixed EL light-emitting sheet 2 may vary depending on the use of the short conductive member 10a or the long conductive member 10b for fixation.

In the embodiment, two output terminals 6 are alternately interposed among three insulating boards 4. However, three or more output terminals 6 may be interposed among four or more insulating boards 4 such that three types of the conductive members 10 are prepared for three output terminals 6 each having a different drive cycle.

In the embodiment, the conductive member 10 with appropriate length is selected from two conductive members 10a and 10b as the “light emitting cycle adjustment pushpin” so as to be used for fixing the EL light-emitting sheet 2 to the insulating board 4. A specific output terminal 6 is selected from plural output terminals 6 interposed between the insulating boards 4, 4 for receiving drive signals each at different output timing. The selected output terminal 6 is selectively conducted with the EL light-emitting sheet 2 in contact therewith through the conductive member for power feeding. This allows the EL light-emitting sheet 2 to emit light at the different cycle in accordance with the output terminal 6 selected based on the specific “light emitting cycle adjustment pushpin”.

In addition to the effects as those derived from the first example, the EL light-emitting device 1b has a laminated structure including plural output terminals 6 and the plural insulating boards 4 for receiving the drive signals at different cycles to allow the plural EL light-emitting sheets 2 attached in the same plane to emit light at different cycles.

Unlike the generally employed clip type EL light-emitting device for power feeding by clipping the EL light-emitting sheet, the EL light-emitting device according to the present invention allows the pin 12 to be pushed to fix the EL light-emitting sheet with sufficient force so as not to fall out even if it is pulled.

The power feeding may be performed with no need of accurate alignment of the positional relationship between the electrodes 3 of the EL light-emitting sheet 2 and the output terminals 6 of the EL light-emitting device 1. It is effective for the use of the EL light-emitting sheet 2 as the frequently exchanged advertizing medium.

The plural EL light-emitting sheets 2 may be attached to the EL light-emitting device 1 whether they are overlapped or not. The light emitting cycle may be arbitrarily set by selecting the cycle of the drive signal transmitted to the thus attached EL light-emitting sheet 2 with the simple structure. As a result, the light-emitting display may be diversified to provide such advantage as improved visual effects conforming to various needs realized by the present invention as advertising media and notice, for example.

In the EL light-emitting device according to the respective embodiments, the EL light-emitting sheet is attached to the insulating board with the pushpin-like conductive member, and is electrically coupled with the output terminal to receive power for light emission. Based on the same principle, the power receiving unit other than the EL light-emitting sheet (the power feeding is not necessarily intended only for light emission) may be attached to be used as the same structure as the EL light-emitting device.

What is claimed is:

1. An EL light-emitting device which fixes an EL light-emitting sheet with an electrode for light emission, comprising:
an insulating board which allows penetration and fixation of the EL light-emitting sheet on a front surface;
an output terminal provided on a back surface of the insulating board, which exhibits conductivity and allows penetration;
a drive circuit connected to the output terminal; and
a conductive member with a pointed portion for fixing the EL light-emitting sheet to a desired position on the front surface of the insulating board and conducting the electrode of the EL light-emitting sheet and the output terminal by penetrating the electrode of the EL light-emitting sheet disposed on the front surface of the insulating board, the insulating board, and the output terminal.

2. The EL light-emitting device according to claim 1,
wherein the EL light-emitting device includes a pair of the output terminals;
the conductive member is separated with an insulating separation member which inhibits penetration of the conductive member; and
the EL light-emitting sheet includes a pair of the electrodes corresponding to the pair of the output terminals.

3. An EL light-emitting device comprising:
an insulating board which allows penetration;
a pair of comb-like output terminals disposed on a back surface of the insulating board which are combined at a pitch of L, each exhibiting conductivity and allowing penetration;
a drive circuit connected to the output terminal;
an EL light-emitting sheet disposed on a front surface of the insulating board, which includes a pair of electrodes arranged at an interval of (2n+1)L to correspond to the pair of the output terminals; and
a conductive member with a pointed portion for fixing the EL light-emitting sheet to a desired position on the front surface of the insulating board, and conducting the electrode of the EL light-emitting sheet and the output terminal by penetrating the pair of the electrodes of the EL light-emitting sheet disposed on the front surface of the insulating board, the insulating board, and the pair of the output terminals.

4. An EL light-emitting device which fixe an EL light-emitting sheet with an electrode for light emission, comprising:
a plurality of insulating boards each allowing penetration, one of which is disposed on a front surface;
a plurality of output terminals each exhibiting conductivity and allowing penetration, which are alternately overlapped with the insulating boards in a width direction;
a drive circuit connected to the output terminals to transmit drive signals each at a different cycle; and
a conductive member with a pointed portion for fixing the EL light-emitting sheet to a desired position on a front surface of the insulating board, and conducting the electrode of the EL light-emitting sheet and only the desired output terminal by penetrating the electrode of the EL light-emitting sheet disposed on the front surface of the insulating board located at the front, the insulating board, and the output terminal.

5. The EL light-emitting device according to claim 4,
wherein the EL light-emitting device includes a pair of the output terminals;
the pair of the output terminals at least disposed on the front surface are separated with an insulating separation member which inhibits penetration of the conductive member; and
the pair of electrodes of the EL light-emitting sheet corresponds to the pair of the output terminals.

6. The EL light-emitting device according to claim 4, wherein the conductive member includes an insulating knob and a pin formed of a conductive material which is attached to the knob to penetrate the electrode of the EL light-emitting sheet, the insulating board, and the output terminal, and conducts only with the output terminal in contact with a leading end portion.

7. The EL light-emitting device according to claim 5, wherein the conductive member includes an insulating knob and a pin formed of a conductive material which is attached to the knob to penetrate the electrode of the EL light-emitting sheet, the insulating board, and the output terminal, and conducts only with the output terminal in contact with a leading end portion.

8. A power feeding device for feeding power to a power receiving unit with an electrode comprising:
an insulating board which allows penetration;
an output terminal disposed on a back surface of the insulating board, which exhibits conductivity and allows penetration;
a drive circuit connected to the output terminal; and
a conductive member with a pointed portion for conducting the electrode of the power receiving unit and the output terminal by penetrating the electrode of the power receiving unit disposed on a front surface of the insulating board, the insulating board, and the output terminal.

9. A power feeding method for feeding power to a power receiving unit with an electrode using a power feeding device provided with an output terminal which exhibits conductivity and allows penetration connected to a drive circuit on a back surface of an insulating board which allows penetration, wherein a conductive member with a pointed portion penetrates the electrode of the power receiving unit on a front surface of the insulating board, the insulating board, and the output terminal to conduct the electrode of the power receiving unit and the output terminal via the conductive member.
